(19) United States
(12) Patent Application Publication
(10) Pub. No.: US 2008/0182652 A1
(43) Pub. Date: Jul. 31, 2008

(54) Wagering Game Machine with Transmissive Lcd Object Blocking

(76) Inventors: James M. Rasmussen, Chicago, IL (US); Ranjan Dasgupta, Naperville, IL (US); Matthew R. Fitzsimons, Lake in the Hills, IL (US); Samuel D. Ralston, Chicago, IL (US)

Correspondence Address: SCHWEGMAN, LUNDBERG & WOESSNER/WMS GAMING, P.O. BOX 2938, MINNEAPOLIS, MN, 55402, US

(21) Appl. No.: 11/995,569

(22) PCT Filed: Jul. 14, 2006
(86) PCT No.: PCT/US2006/027344

§ 371 Date: Jan. 14, 2008

Related U.S. Application Data
(60) Provisional application No. 60/699,686, filed on Jul. 15, 2005.

(51) Int. Cl. A63F 13/00; A63F 9/24; G02F 1/13

(52) U.S. Cl. 463/25; 349/1; 349/74

(57) ABSTRACT

A computerized wagering game system includes a gaming module comprising a processor and gaming code which is operable when executed on the processor to present a wagering game on which monetary value can be wagered via at least one mechanical reel and a liquid crystal display (LCD). The liquid crystal display has at leas tone transparent portion through which the mechanical reel or reels can be observed. A blocking mechanism is operable to selectively limit visibility through the LCD transparent portion, such as for display of graphics on the transparent portion of the LCD display.

### RELATED APPLICATIONS

This application claims the priority benefit of U.S. Provisional Application Ser. No. 60/699,686 filed Jul. 15, 2005, the contents of which are incorporated herein by reference.

### FIELD OF THE INVENTION

The invention relates generally to computerized wagering game machines, and more specifically to blocking objects visible through transmissive lcd panels in computerized wagering game machines.

### COPYRIGHT

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2005, 2006, WMS Gaming, Inc.

### BACKGROUND

Computerized wagering games have largely replaced traditional mechanical wagering game machines such as slot machines, and are rapidly being adopted to implement computerized versions of games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

The elements of computerized wagering game systems are in many ways the same as the elements in the mechanical and table game counterparts in that they must be fair, they must provide sufficient feedback to the game player to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Computerized wagering games do not rely on the dealer or other game players to facilitate game play and to provide an entertaining game playing environment, but rely upon the presentation of the game and environment generated by the wagering game machine itself. Incorporation of audio and video features into wagering games to present the wagering game, to provide help, and to enhance the environment presented are therefore important elements in the attractiveness and commercial success of a computerized wagering game system. It is not uncommon for audio voices to provide instruction and help, and to provide commentary on the wagering game being played. Music and environmental effects are also played through speakers in some wagering game systems to enhance or complement a theme of the wagering game. These sounds typically accompany video presentation of the wagering game on a screen, which itself often includes animation, video, and three-dimensional graphics as part of presentation of the wagering game.

But, many people prefer to see mechanical reels rather than video rendering of a slot machine game, in part due to the more traditional appearance of the rotating slot reels. Presentation of mechanical reels makes the wagering game more enjoyable for some of these people, and so mechanical reel slot machines are still common in many wagering game facilities. But, use of reel slot machines limits the ability of a wagering game machine to present computer graphics and animation to enhance the theme of the wagering game or to provide other information, and so are often less entertaining than LCD (liquid crystal display) touchscreen wagering game systems.

It is therefore desired that the advantages of LCD displays be incorporated into wagering games having mechanical elements such as reel slot machines.

### SUMMARY

One example embodiment of the invention comprises a computerized wagering game system includes a gaming module comprising a processor and gaming code which is operable when executed on the processor to present a wagering game on which monetary value can be wagered via at least one mechanical reel and a liquid crystal display (LCD). The liquid crystal display has at least one transparent portion through which the mechanical reel or reels can be observed. A light blocking element is operable to selectively limit visibility through the LCD transparent portion, such as for display of graphics on the transparent portion of the LCD display.

### BRIEF DESCRIPTION OF THE FIGURES

FIG. 1 shows a computerized wagering game machine, as may be used to practice some example embodiments of the invention.

FIG. 2 shows a side view of a mechanical reel slot machine having an LCD display panel with a transparent region and a blocking element screen, consistent with some example embodiments of the invention.

FIG. 3 shows a side view of a mechanical reel slot machine having an LCD display panel with a transparent region and a roller-mounted screen, consistent with some example embodiments of the invention.

FIG. 4 shows a side view of a mechanical reel slot machine having an LCD display panel with a transparent region and a blocking screen that changes optical transparency, consistent with some example embodiments of the invention.

FIG. 5 shows a flowchart of a method of practicing an example embodiment of the invention.

FIG. 6 shows a side view of a mechanical reel slot machine having an LCD display panel with a transparent region and a selectively illuminated mechanical blocking screen movable on tracks, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

One example embodiment of the invention comprises a computerized wagering game system includes a gaming module comprising a processor and gaming code which is operable when executed on the processor to present a wagering game on which monetary value can be wagered via at least one mechanical reel and a liquid crystal display (LCD). The liquid crystal display has at least one transparent portion through which the mechanical reel or reels can be observed. A light blocking element is operable to selectively limit visibility through the LCD transparent portion, such as for display of graphics on the transparent portion of the LCD display.

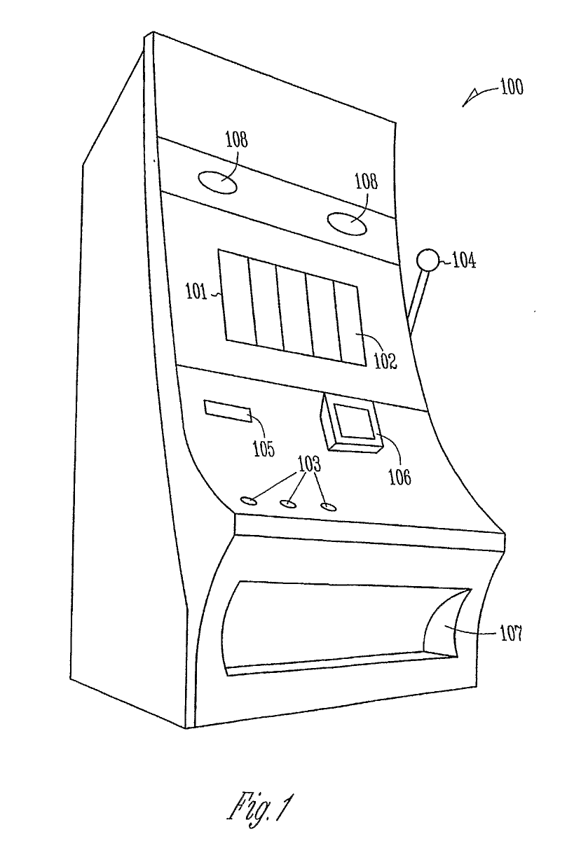

FIG. 1 illustrates a computerized wagering game machine, as may be used to practice some embodiments of the present invention. The computerized gaming system shown generally at 100 is a video wagering game system, which displays information for at least one wagering game upon which monetary value can be wagered on video display 101. Video display 101 is in some embodiments an LCD display having a transparent region that can be seen through, but which is still an active display area. This can be achieved by removing the reflective back layer and other back layers of a typical LCD display panel in the transparent region. In other embodiments, a surface conducting electron emitter display, plasma display, or any other type of display suitable for displaying electronically provided display information is used as long as it can be configured to have a semitransparent portion. The wagering game also features a mechanical game element that can be seen through the transparent portions of the liquid crystal display under some circumstances, such as mechanical reels shown at 102 that comprise a part of a video slot machine wagering game.

A game of chance is implemented using software within the wagering game, such as through instructions stored on a machine-readable medium such as a hard disk drive or nonvolatile memory. In some further example embodiments, some or all of the software stored in the wagering game machine is encrypted or is verified using a hash algorithm or encryption algorithm to ensure its authenticity and to verify that it has not been altered. For example, in one embodiment the wagering game software is loaded from nonvolatile memory in a compact flash card, and a hash value is calculated or a digital signature is derived to confirm that the data stored on the compact flash card has not been altered. The game of chance implemented via the loaded software takes various forms in different wagering game machines, but is in most example embodiments discussed herein a traditional reel slot game using mechanical reels visible through the transparent portions of the liquid crystal display. Other wagering games such as video poker, blackjack, craps, roulette, or hold'em games that use mechanical elements can be used in a similar manner in further examples. The wagering game is played and controlled with inputs such as various buttons 103 or via a touchscreen overlay to video screen 101. In some alternate examples, other devices such as pull arm 104 used to initiate reel spin in this reel slot machine example are employed to provide other input interfaces to the game player.

Monetary value is typically wagered on the outcome of the games, such as with tokens, coins, bills, or cards that hold monetary value. The wagered value is conveyed to the machine through a changer 105 or a secure user identification module interface 106, and winnings are returned via the returned value card or through the coin tray 107. Sound is also provided through speakers 108, typically including audio indicators of game play, such as reel spins, credit bang-ups, and environmental or other sound effects or music to provide entertainment consistent with a theme of the computerized wagering game. In some further embodiments, the wagering game machine is coupled to a network, and is operable to use its network connection to receive wagering game data, track players and monetary value associated with a player, and to perform other such functions.

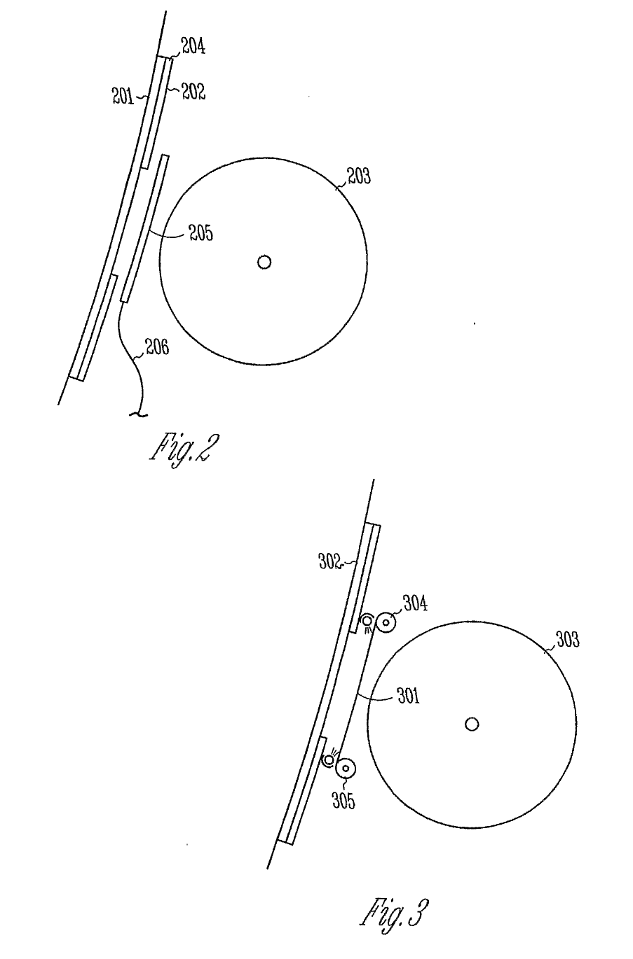

The liquid crystal display panel and mechanical reel are shown in a more detailed view in FIG. 2, consistent with an example embodiment of the invention. The touchscreen liquid crystal display (LCD) panel 201 comprises several layers, including a back reflective layer 202. The back reflective layer 202 is removed from the LCD panel assembly in a region as shown in FIG. 2, so that the front face of the slot machine reel 203 can be easily seen through the LCD panel.

The LCD panel remains operational in this region, and is able to superimpose graphics over the reels visible behind the LCD panel. Each pixel in a typical LCD panel comprises a liquid crystal suspended between two polarizing filters with axes that are perpendicular to each other. In the absence of the liquid crystal presence, light passing through one polarized filter would not be able to pass through the other due to the difference in polarization direction. The liquid crystal element changes the polarization of light that has passed through the first polarizing filter so that its polarization has changed and it can pass through the second polarizing filter.

When an electrical charge is applied to a liquid crystal element in a liquid crystal display pixel, the natural twist of the liquid crystal is undone to a degree dependent on the charge applied as the liquid crystals align themselves parallel to the electric field, thereby reducing the change in polarization by a varying amount and blocking light from passing through both the first and second polarizing filters to a variable degree.

While some LCD displays such as those used in pocket calculators and wristwatches are simply reflective, and use ambient light reflected off a reflective backplane such as back reflective layer 202, most are transmissive panels that are lit via one or more backlights, such as are commonly found in LCD computer monitors and cellular telephones. These transmissive LCD panels rely on backlighting, which is usually distributed across the face of the liquid crystal display panel by a light carrying layer called a diffusion layer 204 that carries and diffuses light injected from the sides of the panel to ensure uniform illumination of the transmissive LCD panel.

This principle can be used to create a color display by using a red, green, and blue subpixel for each pixel location, so that a full color spectrum can be displayed for each pixel by varying the amount of these three light primary colors that is visible. This is done by varying the voltages applied to each of the three colored subpixels, thereby varying the amount of colored light from the backlight diffuser layer of the display panel that reaches the viewer.

The back side of the liquid crystal display panel is therefore almost always an opaque surface designed to reflect light, to illuminate the display pane. In some embodiments of the invention such as are shown in FIG. 2, the back reflective coating is removed from a portion of the LCD display panel, allowing light to pass through the panel when the LCD elements are not energized. As FIG. 2 shows, a mechanical element such as a slot machine reel 203 placed behind the LCD display panel is then visible, resulting in a display that allows presentation of both computer graphics or video and of a mechanical element located behind the portion of the LCD display panel that lacks a reflective backing.

The slot machine assembly of FIG. 2 further includes a blocking element 205, designed to block visible light from the background object such as reel 203 from being visible through the transparent portion of the LCD display. The blocking element serves in various embodiments to physically interrupt or redirect the light reflected or emitted from the mechanical element 203, or in other embodiments diffuses the light from the mechanical reels or obscures it using other lighting sources or methods.

The transparent portion is here blocked using a second liquid crystal display screen 205, operable when actuated to change polarization. Because the light passing through the transparent portion of liquid crystal display panel 201 is polarized, a selective polarization element such as a second liquid crystal display panel 205 can be used to selectively block or transmit the polarized light through simply changing the polarization of at least a portion of the LCD panel.

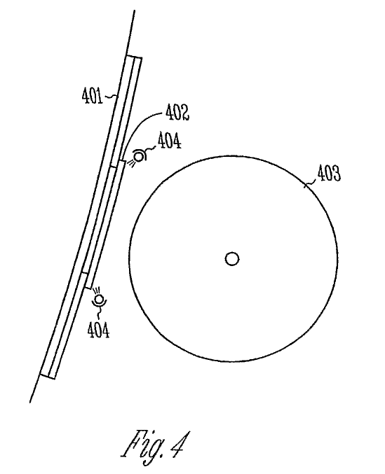

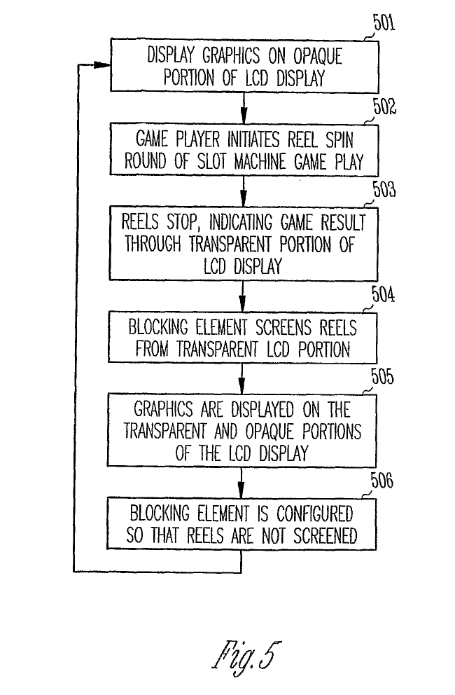

The second liquid crystal display element 205 is in some embodiments actuated via a computerized wagering game control system, via one or more wires 206 carrying a control signal to the liquid crystal display. Other embodiments will use other screens in place of the liquid crystal display 205 used here as a selective polarizer, such as is shown in FIGS. 3 and 4. Application of heat, electricity, light, or other stimulus changes the state of some such materials such that the apparent opacity, color, or luminosity can be controlled. Examples of other technologies that can be substituted for a liquid crystal display screen include use of thermotropic materials, photochromatic materials, suspended particle mediums, reflective hydride materials, and electrochromic materials.

The blocking element can be used to obscure the mechanical reels or other mechanical objects while increasing visibility of graphics or video displayed on the transparent portions of the liquid crystal display. This allows the display to function as a full-screen display for presentation of video, configuration or setup screens, or other graphics in which use of the full display region is desired. In a further example, specific reels can be obscured or shown individually via independent actuation of blocking elements obscuring different reels or game elements, such as in a wagering game in which a user can buy or be awarded an extra reel for an increased chance of winning.

FIG. 3 illustrates another example embodiment of the invention in which a screen 301 having a transparent portion and an opaque portion is configured between the liquid crystal display 302's transparent portion and a mechanical element such as the slot machine mechanical reel 303. The screen shown here is a flexible screen mounted on rollers 304 and 305, which are operable to rotate to expose different portions of the screen element between the liquid crystal display 302 and the mechanical reel 303. For example, in one embodiment a top portion of the screen is opaque and a bottom portion of the screen is optically transparent. The rollers 304 and 305 are actuated via electric motors to selectively position either the top opaque portion of the screen or the bottom transparent portion of the screen 301 between the liquid crystal display's transparent portion and the mechanical reel, thereby either blocking or passing light emitted by or reflected off the mechanical reel 303 to a viewer on the other side of the liquid crystal display 302.

Further embodiments include lights 306, which are operable to illuminate the opaque blocking portion of the screen 301 when it is positioned between the liquid crystal display and the mechanical reels, and to shut off when the transparent portion of the screen is exposed to prevent reflections or glare from the screen 301 from interfering with viewing the mechanical reel 303 through the liquid crystal display 302's transparent portion. The lights 306 are further able to backlight the LCD display, by reflecting off the opaque portion of the screen 301 and on to the transparent portion of the liquid crystal display. In such applications, the lights can be configured in direction and brightness to backlight the transparent portion of the liquid crystal display in approximately the same way as the opaque portion of the liquid crystal display, so that images displayed across the opaque and transparent portions appear more uniform.

Although this example illustrates mechanical deployment of a screen using rollers, a wide variety of other mechanisms can be used to similarly deploy a screen to obscure a mechanical wagering game element in other embodiments of the invention. Examples include use of a screw drive to position a screen, or use of cables, lever arms, gear-driven mechanisms, and

FIG. 4 illustrates an embodiment in which the wagering game system includes a screen 402 which is substantially optically transparent located between the liquid crystal display 401 and the mechanical slot reel 403. The screen includes a coating or dispersion of a fluorescent material such as phosphorous, that when excited such as by ultraviolet light from lights 404, by an applied electric voltage, or by some other means changes in fluorescence or transparency. As an example, consider a screen 402 made of glass that has phosphors dispersed throughout the glass such that the glass screen remains substantially transparent when exposed to normal light. When the reels are lit, and ultraviolet lights 404 are not lit, the reels will therefore be clearly visible through the transparent portion of the liquid crystal display screen. When the reels are not lit and ultraviolet lights 404 are lit, the reels are dark, and the glass screen 402 emits light as a result of the ultraviolet light striking the phosphors dispersed in the glass screen. This results in a backlight effect for the transparent portion of the liquid crystal display panel, and results in obscuring visibility of the mechanical reel assembly 403.

Other examples consistent with the configuration shown in FIG. 4 include use of a screen 402 that is partially optically transparent, such as a glass screen that is smoky or milky in appearance such that it appears optically transparent when lit from behind, but appears significantly optically opaque when lit from the front or when the reels are not lit.

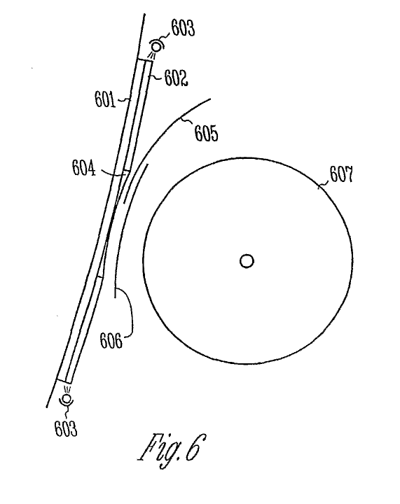

Application of a blocking element to block a transparent portion of a liquid crystal display in a wagering game is describe in greater detail with reference to the flowchart of FIG. 5. At 501, the wagering game system displays graphics on the opaque portion of the liquid crystal display, such as graphics related to a theme of the wagering game, or animations, accumulated credits, video, instructions, or other such graphics. The graphics are displayed and the slot reels are lit and visible when the wagering game player initiates a round of game play by starting a reel spin of the slot machine at 502. The reels spin and stop sequentially at determined locations, indicating a result of the game event at 503, and because the reels are lit and the screen 503 is not configured to obscure the reels, the reels are visible to the wagering game player through the transparent portion of the liquid crystal display.

At 504, the blocking element screens the reels from the transparent portion of the liquid crystal display. In some embodiments, this involves physically moving an opaque screen between the reels and the transparent portion of the liquid crystal display, such as is shown and described in FIG. 3. In other embodiments, a screen's state is changed, such as when the second liquid crystal display as shown and described in FIG. 2 changes in transparency or polarization, or when a screen changes transparency or luminescence as a result of application of an external stimulus such as lighting or electricity.

Graphics are then displayed on the liquid crystal display screen at 505, extending across the transparent and opaque portions of the display. The screen is configured in some embodiments to either emit or reflect light toward the transparent portion of the display, such that the transparent portion of the liquid crystal display is backlit. The backlighting effect can be controlled such that the backlighting provided to the transparent portion of the liquid crystal display is similar to that provided internally to the opaque portions of the liquid crystal display, so that graphics displayed across the opaque and transparent portions of the display appear relatively uniform in brightness and contrast.

At 506, the blocking element is configured so that the reels are once again not screened, and graphics are shown on the opaque portion of the liquid crystal display such that the reels are illuminated and ready for another round of game play at 502. In an alternate embodiment, graphics are displayed on the transparent portion of the liquid crystal display even when the reels are visible, and can be used for various purposes such as to highlight certain reel symbols or accentuate certain paylines indicating a sequence of winning reel symbols.

FIG. 6 shows another example of a mechanical blocking element, along with an example lighting method for illuminating the screen and improving visibility of graphics displayed on the transparent portion of the liquid crystal display. The liquid crystal display 601 has a light diffusion layer 602, and in many embodiments includes other layers such as a rear opaque layer and a rear dust shield or enclosure. The light diffusion layer and any rear opaque layers are cut away to form the transparent regions of the liquid crystal display, and a transparent dust shield 604 shields the rear of the transparent regions and conducts light from lamps 603 carried through the light diffusion layer 602 and into the dust shield 604 onto a blocking member 605 when inserted in channel 606. The blocking member 605 is in some embodiments made of a light colored opaque medium such as white plastic, and is moved mechanically through a transparent guide 606 or through a guide 606 that is not transparent but that is configured not to be visible through the transparent region of the liquid crystal display, such as a guide that guides only the edges of screen 605.

The screen 605 is illuminated by light scattered from the transparent dust shield element 604 onto the screen when fully inserted in the guide 606, such that the light reflected off the screen 606 serves to backlight or illuminate the back side of the transparent portion of the liquid crystal display. This serves to make graphics or video displayed on the transparent portion of the display more visible and makes images displayed across the entire liquid crystal display surface more uniform, such as when viewing full-screen video or when viewing a setup screen in a game configuration or troubleshooting mode.

Other embodiments will include other physical screen configurations and other methods of actuating or moving the screen, as well as other methods of lighting the side of the screen visible through the transparent portion of the liquid crystal display. Examples include a screen that is guided by tracks but does not remain rigid when retracted, such as a garage door-type mechanism. A collapsible shutter resembling honeycomb blinds commonly used in residential windows can also be used as a blocking element, and can be configured with the visible side illuminated if the blind is substantially opaque or from the reel side when the blind is partially opaque. In still other examples, the reel itself is illuminated or is a secondary display device, and emits light that backlights a partially opaque screen that can be retracted to make the reel visible or can be deployed to obscure the reel and provide backlight to the transparent portion of the liquid crystal display.

The examples given here show how a blocking element can be used in a wagering game having a liquid crystal display with a transparent portion to selectively permit viewing of an object through the transparent portion of the display. Although certain examples of a blocking element are shown and described here, other blocking elements and other variations exist and are within the scope of the invention. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A computerized wagering game system, comprising:
a gaming module comprising a processor and gaming code which is operable when executed on the processor to present a wagering game on which monetary value can be wagered and including at least one mechanical game object;
a liquid crystal display (LCD) having at least one transparent portion through which the at least one mechanical game object can be observed; and
a blocking element operable to selectively obscure the mechanical game object, reducing its visibility through the transparent portion of the liquid crystal display.

2. The computerized wagering game system of claim 1, further comprising an illumination element operable to illuminate the blocking element.

3. The computerized wagering game system of claim 1, wherein the at least one mechanical game object is a reel slot machine symbol reel.

4. The computerized wagering game system of claim 1, wherein the blocking element comprises a second liquid crystal display screen, operable when electrically actuated to change polarization relative to the liquid crystal display having at least one transparent portion.

5. The computerized wagering game system of claim 1, wherein the blocking element comprises a screen that is at least partially opaque.

6. The computerized wagering game system of claim 5, wherein the screen is illuminated with a light.

7. The computerized wagering game system of claim 5, wherein the screen is operable to emit light when stimulated with at least one of electricity, ultraviolet light, or visible light.

8. The computerized wagering game system of claim 5, wherein the screen is operable to mechanically change position to selectively permit viewing the mechanical game object through the at least one transparent portion of the liquid crystal display.

9. A method of operating a computerized wagering game system, comprising:
presenting a wagering game on which monetary value can be wagered including at least one mechanical game object;
displaying an image on a liquid crystal display (LCD) having at least one transparent portion through which the at least one mechanical game object can be observed; and
selectively obscuring the mechanical game object via a blocking element, reducing the mechanical game object's visibility through the transparent portion of the liquid crystal display.

10. The method of claim 9, further comprising illuminating the blocking element.

11. The method of claim 9, wherein the at least one mechanical game object is a reel slot machine symbol reel.

12. The method of claim 9, wherein the blocking element comprises a second liquid crystal display screen, and further comprising selectively changing polarization of the second liquid crystal display screen relative to the liquid crystal display having at least one transparent portion.

13. The method of claim 9, wherein the blocking element comprises a screen that is at least partially opaque.

14. The method of claim 13, further comprising illuminating the screen with a light.

15. The method of claim 13, wherein the screen is operable to emit light when stimulated with at least one of electricity, ultraviolet light, or visible light.

16. The method of claim 13, wherein selectively obscuring the mechanical game object via a blocking element comprises changing a position of the screen to selectively permit viewing the mechanical game object through the at least one transparent portion of the liquid crystal display.

17. A display panel apparatus, comprising:
a liquid crystal display (LCD) element having at least one optically transparent portion through which light is able to pass through the liquid crystal display panel apparatus; and
a blocking element operable to selectively block light from passing through the transparent portion of the liquid crystal display.

18. The display panel apparatus of claim 17, wherein the blocking element comprises a second liquid crystal display panel operable to change polarization when electrically actuated to selectively block light from passing through the transparent portion.

19. The display panel apparatus of claim 17, wherein the blocking element comprises a mechanical screen configurable to selectively block light from passing through the transparent portion.

20. The display panel apparatus of claim 17, wherein the blocking element is electrically actuatable to selectively block light from passing through the transparent portion.
